(19) United States
(12) Patent Application Publication
(10) Pub. No.: US 2024/0408484 A1
(43) Pub. Date: Dec. 12, 2024

(54) AI HIGHLIGHT DETECTION TRAINED ON SHARED VIDEO

(71) Applicant: Sony Interactive Entertainment LLC, San Mateo, CA (US)

(72) Inventor: Chen Yao, Bloomingdale, IL (US)

(21) Appl. No.: 18/208,191

(22) Filed: Jun. 9, 2023

(51) Int. Cl. A63F 13/52; G06F 3/01; G06V 10/44; G06V 10/764; G06V 10/82

(52) U.S. Cl. CPC A63F 13/52; G06F 3/013; G06V 10/44; G06V 10/764; G06V 10/82

(57) ABSTRACT

A system, device, and method of training for detection and generation of a gameplay highlight are disclosed. An application is run and one or more inputs for the application and application data are provided to a trained highlight detection neural network, which is trained to predict at least one highlight determined from at least one of the application data and the one or more inputs for the application.

### FIELD OF THE DISCLOSURE

Aspects of the present disclosure relate to game services specifically the present disclosure relates detection of and generation of application highlights using machine learning.

### BACKGROUND OF THE DISCLOSURE

Applications such as video games are engaging experiences that users often want to share. Users may get too caught up in the gaming experience to realize they would like to share it. At other times the user may want to share an experience, but the most exciting part of the experience has passed. If they want to catch that perfect moment, they will have to go back and replay a part of the video game to find the moment again.

Social media and streaming video sites have made sharing videos and images easier than ever. This wealth of information has also made it easier to develop metrics regarding what interests the average user.

It is within this context that aspects of the present disclosure arise.

### BRIEF DESCRIPTION OF THE DRAWINGS

The teachings of the present disclosure can be readily understood by considering the following detailed description in conjunction with the accompanying drawings, in which:

FIG. 1 is a diagram of an example of a system architecture for generating highlights either on a client device or as networked service according to an aspect of the present disclosure.

FIG. 2 is a diagram of another example system architecture according to aspects of the present disclosure.

FIG. 3 is a diagram showing an example system architecture with highlight generation having sources of unstructured data according to aspects of the present disclosure.

FIG. 4 depicts an example of decomposition of a game screen for identification of a game highlight and generation of the highlight with the highlight detection module according to aspects of the present disclosure.

FIG. 5 is a diagram depicting an example of sentiment classification of audio data by the highlight detection engine according to aspects of the present disclosure.

FIG. 6 is a diagram showing an example of text sentiment classification by one or more modules of the highlight detection module according to aspects of the present disclosure.

FIG. 7 is a diagram depicting an example of sentiment classification of peripheral inputs data by the highlight detection engine according to aspects of the present disclosure.

FIG. 8A is a diagram depicting an example of interest classification of eye tracking inputs according to aspects of the present disclosure.

FIG. 8B is a diagram depicting an example of sentiment classification of motion inputs according to aspects of the present disclosure.

FIG. 9 shows an example system for providing a data model and highlight detection engine with a uniform data platform according to aspects of the present disclosure.

FIG. 10 is a diagram depicting an example of using correlation of inputs and viewership data during training with the highlight detection engine according to aspects of the present disclosure.

FIG. 11 is a diagram depicting an example layout of modal modules in a multi-modal recognition network of the highlight detection engine according to aspects of the present disclosure.

FIG. 12 is a diagram depicting an example of an implementation of hierarchical filtering using unimodal modules with multi-modal highlight detection neural network of the highlight detection engine according to aspects of the present disclosure.

FIG. 13A is a simplified node diagram of a recurrent neural network according to aspects of the present disclosure.

FIG. 13B is a simplified node diagram of an unfolded recurrent neural network according to aspects of the present disclosure.

FIG. 13C is a simplified diagram of a convolutional neural network according to aspects of the present disclosure.

FIG. 13D is a block diagram of a method for training a neural network that is part of the multimodal processing according to aspects of the present disclosure.

FIG. 14 is a block diagram of a system implementing the highlight detection engine generating context according to aspects of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the present disclosure. Accordingly, examples of embodiments of the disclosure described below are set forth without any loss of generality to, and without imposing limitations upon, the claimed disclosure.

Modern game consoles use structured context information to provide additional services for the user. These additional services may provide new types of functionalities for games running on the console. For example and without limitation, the new types of functionalities may include help screens using player data, operating system provided player statistics, game plans, Game session data, tournament data, and presence data. Enabling these functions requires a large amount of data provided by the game to the console in a structured way so that the console may use and understand the data, this structured data may also be referred to as context information or structured context information. Users generally capture their own highlights based on their own preferences. It can be a laborious task for a user to find and generate the perfect highlight for their game. The large amount user information in the structured context information may enable the system to generate highlights for the user using machine learning.

Multi-modal neural network systems can use data having multiple modalities and predict a label that takes into account the modalities of data. The different modalities of data provided to a game console may include for example and without limitation, audio data, video data, peripheral input data, eye tracking data, text chat and user generated data. To enable new functionality and provide users with highlights they may be excited to see multi-modal data may be used with a highlight detection engine that includes at least one multi-modal neural network to generate predict a highlight to be shown to the user.

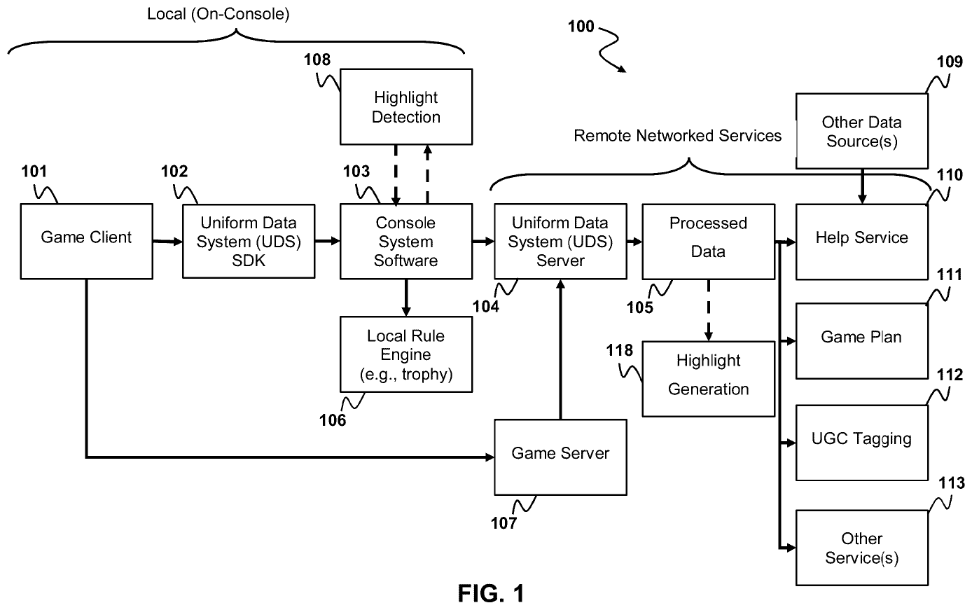

FIG. 1 is a diagram of an example of a system architecture 100 for generating contextual information from unstructured data and providing the contextual information to services that provide users with information regarding available game activities and game status according to an aspect of the present disclosure. In some implementations the system 100 includes a game client 101, a uniform data system (UDS) software development kit (SDK) 102, console system software 103, a local rule engine 106 (e.g., to generate trophies), a UDS server 104, processed data 105, a client side highlight detection engine 108 and one or more networked services including a help service 110, game plan 111, user generated content (UG) tagging 112, a highlight detection service 118, and other service(s)113. The help service may also receive information from other data source(s) 109.

The game client 101 and game server 107 may provide contextual information regarding a plurality of applications to a uniform data system (UDS) service 104 via a UDS data model describing the logical structure of UDS data used by the UDS SDK 102. The UDS data 102 may be provided to a client-side highlight detection engine 108. The highlight detection client-side engine uses the UDS data to identify and create highlights from the plurality of applications running on the client device. The highlight detection engine may share the highlight with the UDS data model and/or the game client. The UDS data model enables the platform to create remote networked services, such as the help service 110, game plan 111, UG content tagging 112, highlight generation 118, and other service(s) 109 that require game data, without requiring each game to be patched separately to support each service. The UDS data model assigns contextual information to each portion of information in a unified way across games. The contextual information from the game client 101 and UDS SDK 102 is provided to the UDS server 104 via the console system software 103. The UDS server 104 may include a data handler that receives UDS data over a network. The highlight generation service 118 may identify and generate highlights from the plurality of applications from the contextual information. The highlights may be provided to the game console or accessible over the network. In some implementations some initial processing for highlight detection module may be performed locally on console by a highlight detection module 108 and the highlight features may be sent to the remote servers 118 for final highlight detection and generation. In other implementations, multiple remote devices may take part in the detection of highlights wherein the client device sends application data to an intermediary remote server where highlight features are generated and the intermediary server my send the highlight features to a final server where the highlights are detected and may be generated. The highlight generation service may include all of the same processing elements as the highlight detection engine but remote to the console.

The UDS server 104 receives and stores contextual information from the game client 101 and game server 107. The contextual information from the game client may either be directly provided by the game client in the UDS format or generated from unstructured game data by an inference engine (not shown). The UDS server 104 may receive contextual information from a plurality of game clients and game servers for multiple users. The information may be uniformly processed 105 and received by the plurality of networked services 110, 111, 112, 118, and 113.

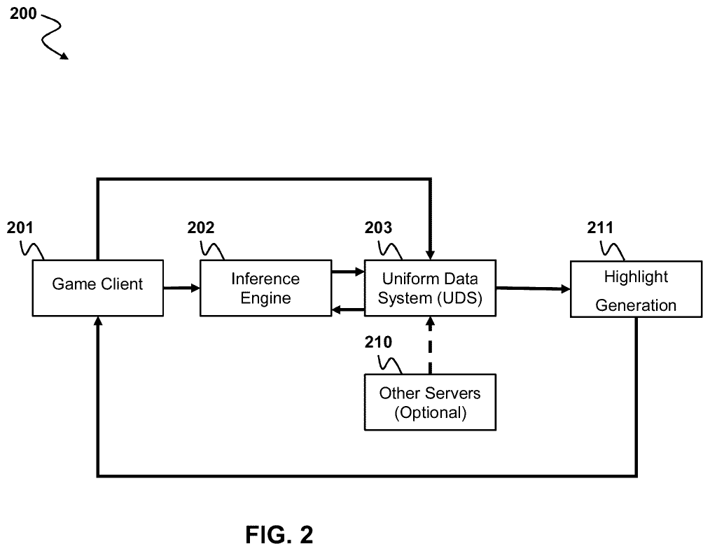

FIG. 2 shows another example system architecture 200 according to aspects of the present disclosure. A game client 201 may send contextual information to a UDS system 203. The game client 202 may also provide unstructured data to the inference engine 202 which may then create structured context information from the unstructured data and provide that context information to the UDS system 203. Structured context information may also be shared in the reverse direction from the UDS system to game client and inference engine to further support the generation of structured context information. The UDS system 203 provides contextual information to a plurality of services including the highlight generation service 211. The UDS system 203 may be implemented on a remote server or may be implemented locally on the client. The local UDS system 203 may receive aggregated UDS data from other servers to generate the services. For example and without limitation, the UDS system may receive profile information from a user profile server to generate profile stats. Similarly, the UDS system may receive tournament information from a tournament server to generate a tournament service.

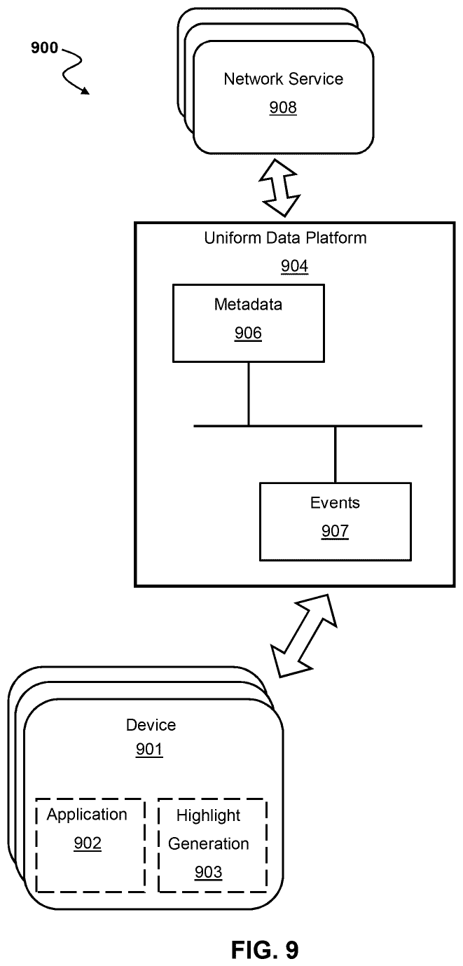

FIG. 9 shows an example system for providing a data model with a highlight detection engine and a uniform data platform 900 according to aspects of the present disclosure. In the implementation shown the system 900 includes at least one device 901 configured to execute a plurality of applications 902; each application may have an application data structure (also referred to as contextual information) available to the device. A highlight generation engine 903 may use the contextual information to generate highlights from the application 902 running on at least one device 901. The highlight may be provided to the uniform data platform 904 or back to at least one device 901. A uniform data platform 904 can be executed on one or more servers or on the device. The uniform data platform 904 includes a data model which is uniform across the plurality of application data structures that are available to the device. The data model may include metadata 906 corresponding to at least one object indicated in the data model and events 907 corresponding to a trigger condition with at least one metadata entry. The values of the meta data 906 and events 907 can be associated with a user profile. The uniform data platform 904 may be configured to receive application data from at least one device 901 and store the application data within the data model. The system can also include a plurality of remote networked services 908 configured to access the application data from the uniform data platform 904 using the data model.

In some implementations the metadata 906 may include: a list of all activities a user can do in an application, an activity name, a description of the activity, a state of the activity (whether available, started, or completed), whether the activity is required to complete an objective or campaign, a completion reward for the activity, an intro or outro cutscene, an in-game location, player location within the game, one or more conditions that must be met before the activity becomes available, and a parent activity that contains the activity as a sub-activity. Metadata 906 may further include: a list of abilities and effects that take place including corresponding timestamps and locations, an in-game coordinate system, a list of in-game branch situations, and telemetry indicative of when a branch situation is encountered, and which option is selected by the user. A list of in-game statistics, items, lore, in-game zone and corresponding attributes regarding each statistic, item, lore, or zone may also be included in metadata 906. Additionally, the metadata 906 may indicate whether or not a particular activity, entity (such as a character, item, ability, etc.), setting, outcome, action, effect, location, or attribute should be marked as hidden.

Events 907 may be initiated in response to various trigger conditions. For example and without limitation, trigger conditions may include: an activity that was previously unavailable becomes available, a user starts an activity, a user ends an activity, an opening or ending cut scene for an activity begins or ends, the user's in-game location or zone changes, an in-game statistic changes, an item or lore is acquired, an action is performed, an effect occurs, the user interacts with a character, item, or other in-game entity, and an activity, entity, setting, outcome, action, effect, location or attribute is discovered. The events may include additional information regarding a state of the application when the events 907 where trigger, for example a timestamp, a difficulty setting and character statistics at the time a user starts or ends an activity, success or failure of an activity or a score or duration of time associated with a completed activity.

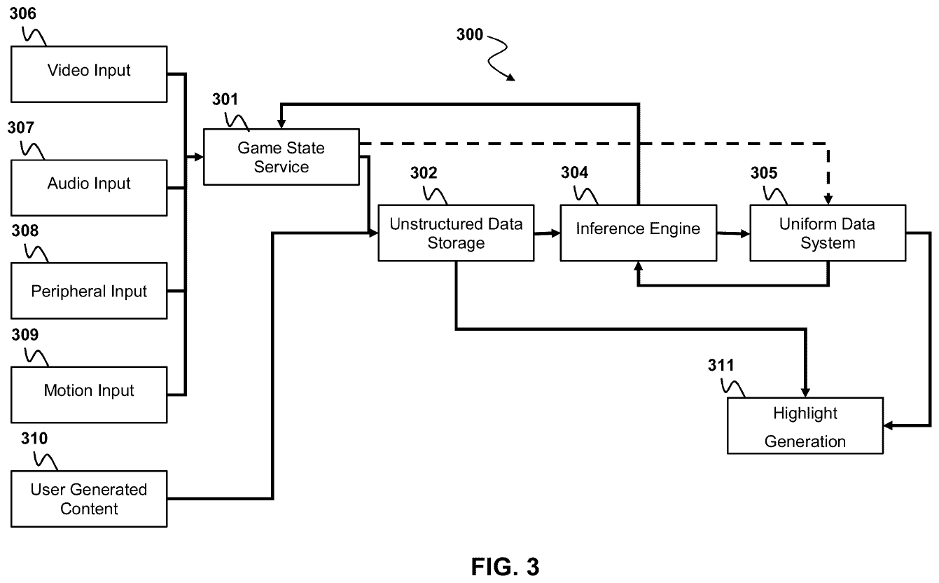

FIG. 3 a diagram showing an example system architecture 300 with highlight detection having sources of unstructured data according to aspects of the present disclosure. In the implementation shown the system 300 is executing an application that does not expose the application data structure to the uninform data system 305. Instead, the inputs to the application such as peripheral input 308 and motion input 309 are interrogated by a game state service 301 and sent to unstructured data storage 302. The game state service 301 also interrogates unstructured application outputs such as video data 306 and audio data 307 and stores the data with unstructured data storage 302. Additionally, user generated content (UGC) 310 may be used as inputs and provided to the unstructured data storage 302. The game state service 301 may collect raw video data from the application which has not entered the rendering pipeline of the device. Additionally, the game state service 301 may also have access to stages of the rendering pipeline and as such may be able to pull video data from different rendered layers which may allow for additional data filtering. Similarly raw audio data may be intercepted before it is converted to an analog signal for an output device or filtered by the device audio system.

The inference engine 304 receives unstructured data from the unstructured data storage 302 and predicts context information from the unstructured data. The context information predicted by the inference engine 304 may be formatted in the data model of the uniform data system. The inference engine 304 may also provide context data for the game state service 301 which may use the context data to pre-categorize data from the inputs based on the predicted context data. In some implementations, the game state service 301 may provide game context updates at update points or at game context update interval to the UDS 305. These game context updates may be provided by the UDS 305 to the inference engine 304 and used as base data points that are updated by context data generated by the inference engine.

The context information may then be provided to the UDS service 305. As discussed above the UDS may be used to provide additional services to the user such as highlight detection 311. The highlight detection engine 311 may also receive unstructured data 302 which may be used in the detection of highlights. The UDS service 305 may also provide structured information to the inference engine 304 to aid in the generation of context data.

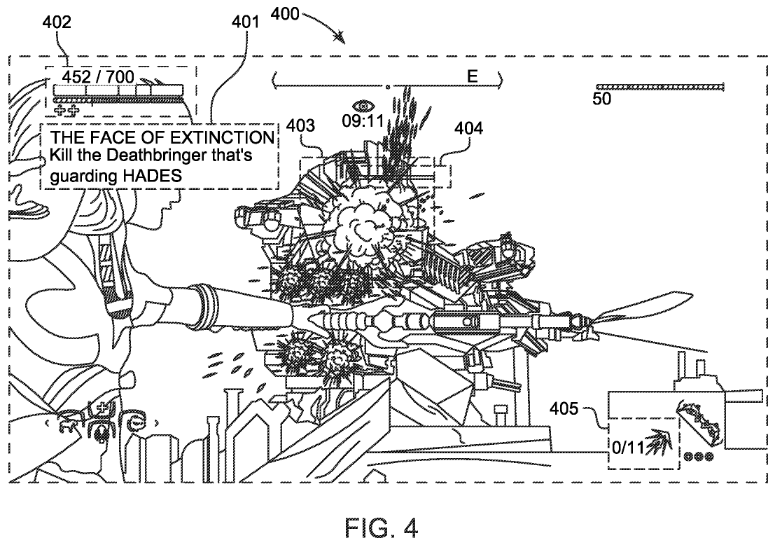

FIG. 4 depicts an example of detection and generation of an application highlight in the form of a screen shot 400 with the highlight detection engine according to aspects of the present disclosure. The structured application data holds a large amount of information that may be analyzed by the highlight detection engine to predict when a user may be interested in capturing a highlight. For example, the highlight detection engine may be trained with a machine learning algorithm to identify from structured data that the screen is showing an interesting/exciting event that the user may want to capture. The structured data may include information that may be predicted to indicate a potential game highlight by the highlight detection engine such information including; the game being on a main quest 401, the enemy is at low health 404, the user's character is at low health 402, the user's amino is low 405 or the user just scored a critical hit on a boss 403 at the boss's weak point. The highlight detection engine may identify potential application highlights from structured application data as discussed and in some implementations the highlight detection engine may be further trained to identify specialized highlights based on, for example and without limitation, the game title. The highlight detection engine with specialized training may predict a game specific highlight for the scene based on the game title and structured information so the potential highlight may be more specifically tied to the game context occurring in the highlight 400 may be for example the game is on the final quest 401, one more critical hit will kill the boss 403, the boss is still alive and the player is out of ammo 405, an exciting cut scene will occur once the boss is dead, etc.

The output of a multimodal highlight detection neural network may include a classification associated with a timestamp of when the highlight occurred in the application data. The classification may simply confirm that a highlight occurred or may provide a sentiment associated with the highlight. A buffer of image frames correlated by stamp may be kept by the device or on a remote system. The highlight detection engine may use the timestamp associated with the classification to retrieve the image frame 400 of the highlight from the buffer. In some implementations the output of the multimodal highlight detection neural network includes a series or range of time stamps and the highlight detection engine may request the series of timestamps or range of time stamps from the buffer to generate a video highlight. In some alternative implementations the highlight detection engine may include a buffer which receives image frame data and organizes the image frames by timestamp.

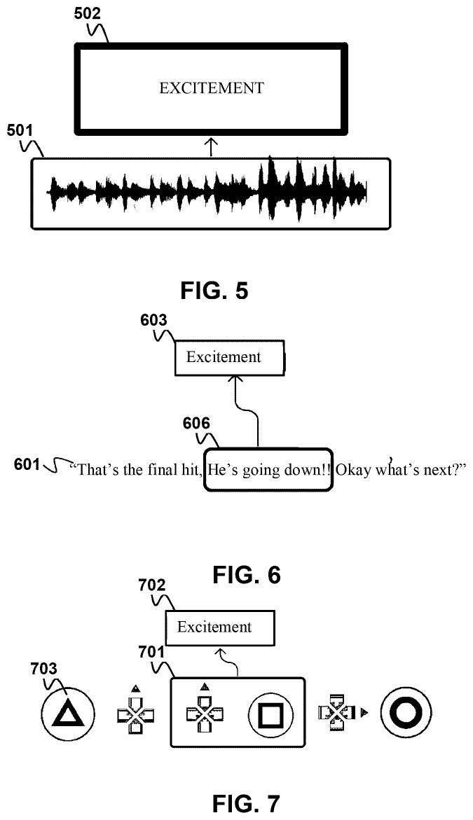

FIG. 5 is a diagram depicting an example of sentiment analysis of recorded user audio data by one or more modules of the highlight detection engine according to aspects of the present disclosure. The highlight detection engine may be a multi-modal system which includes different modules which may include neural networks trained to classify sentiment in recorded audio. In the implementation shown, the recorded audio is represented as a waveform 501, the module of the highlight detection engine is trained to generate a sentiment classification such as excitement 502 from the sound wave form that includes a recorded excitement sounds from the users. Sentiments for example, interest, excitement, curiosity etc. may indicate that a potential highlight is occurring in the application. Additionally in some implementations the audio detection module may also analyze sentiment of game audio to determine whether an exciting or interesting moment is occurring within the application. For example and without limitation, audio cues such as crescendos, diminuendos and a series of staccato notes may indicate an exciting or interesting moment is occurring. Additionally in some implementations the audio detection module may be trained on responses from the user to recognize user specific responses in the recorded audio. The system may request user feedback to refine the classification of user responses. This sentiment classification may be passed as feature data to a multimodal neural network trained to identify highlights.

FIG. 6 is a diagram showing an example of sentiment analysis of text data by one or more modules of the highlight detection engine according to aspects of the present disclosure. The highlight detection engine may be a multi-modal system which includes different modules which may include neural networks trained to recognize sentiment from parts of text from the user text. In the implementation shown the text is an in-application chat 601 from the user, the module of the highlight detection engine is trained to classify sentiment from the text and classifies this segment 606 of the chat as presenting the sentiment of excitement 603. The module shown recognizes the phrase “He's going down!! !” as expressing the sentiment of excitement and provides that feature 603 each time such a text segment is detected. The output of the audio recognition module may be both the highlight feature 603 and segment of text 606 that includes the feature. Alternatively, the output may be the highlight feature 603 and a time stamp for when the text occurred. The segment of audio 602 that corresponds to the feature in the segment of text 606 may also be output by the module. In some implementations the module may include optical character recognition components which may convert text from images that is not machine readable to machine readable form.

FIG. 7 is a diagram depicting an example of sentiment recognition of peripheral input data by one or more modules of the highlight detection engine according to aspects of the present disclosure. The highlight detection engine may be a multi-modal system which includes different modules which may include neural networks trained to recognize sentiments from sequences of button presses.

As shown the peripheral input 703 from the structured data may be a sequence of button presses. Each button press may have a unique value which differentiates each of the buttons. Additionally, the input detection module may also provide time between inputs and/or a pressure applied by the user to each button press. Seen here the peripheral inputs 703 are the buttons: circle, right arrow, square, up arrow, up arrow, triangle. From the inputs the input detection module classifies the peripheral input sequence of square then up arrow 701 as having the sentiment of excitement thus the input detection module outputs feature 702 representing that the user is experiencing excitement. Additionally, the sequence recognition module may also output the sequence of buttons 701 that triggered feature. While the above discusses button presses it should be understood that aspects of the present disclosure are not so limited and the button presses recognized by the sequence recognition module may include joystick movement directions, motion control movements, touch screen inputs, touch pad inputs and similar.

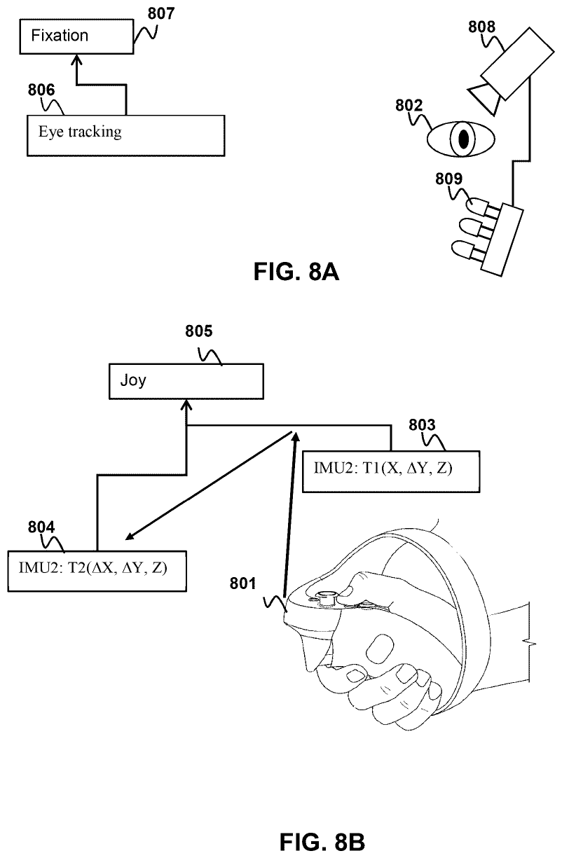

FIG. 8A is a diagram depicting an example of eye tracking classification from structured data according to aspects of the present disclosure. In some implementations the highlight detection engine may include one or more modules configured to classify sentiment eye tracking inputs. As shown the system may include eye tracking located in a located in a heads-up display (HUD). The eye tracking may include an eye tracking camera 808 and glint generator 809. The glint generator may be an arrangement of infrared emitters configured to generate glints in the eyes 802 of the user. The glints and eyes of the user may be recorded by the eye tracking camera 808 to generate recorded eye data and eye tracking coordinates 806 may be determined by the system from the recorded eye data. The eye tracking module may be trained with a machine learning algorithm to classify fixation or other indicators of interest 807 from the eye tracking coordinates 806. Alternatively, the eye tracking classification module may classify fixation or other indicator of interest from the recorded eye data. The classification may then be sent as feature data to the multimodal highlight detection neural network.

FIG. 8B is a diagram depicting an example of motion tracking classification from structured data according to aspects of the present disclosure. Inertial measurement units (IMU)s may be located on peripheral units such as game controllers 801 and HUDs. The IMUs may generate motion data 804 during use. The motion tracking classification module may be trained to differentiate between motion inputs from the HUD, the game controller and other motion devices or alternatively a separate motion control classification module may be used for each motion input device (controller, left VR foot controller, right VR foot controller, left VR hand controller, right VR hand controller, HUD etc.) in the system. As shown the output of the IMUs may be a time series change in acceleration, the controller is moved first upward and the controller IMU2 outputs a first acceleration value 1003 with a change in the Y variable. The user then moves the controller in a downward diagonal direction and the IMU2 outputs a second acceleration value showing change in acceleration in the X and Y variable. The motion tracking classification module classifies the time series IMU input as an expression of joy 805 and outputs the classification as a feature. Additionally, the motional control classification module may output the time series motion input data along with the classification.

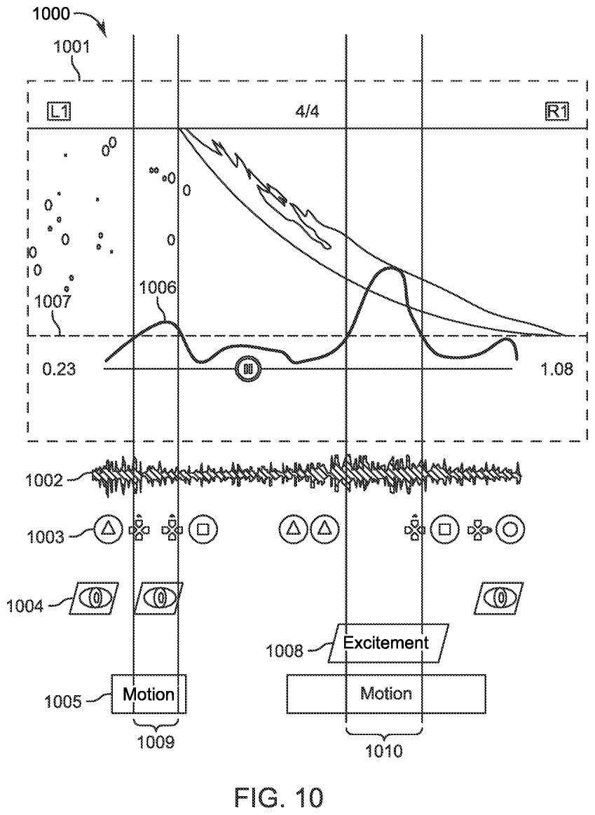

FIG. 10 is a diagram depicting an example of multimodal training data used for training the highlight detection modules of the highlight detection engine according to aspects of the present disclosure. As shown the highlight detection module may be trained on data in multiple modalities, including video/image frames 1001, audio data 1002, peripheral inputs 1003, eye tracking data 1004, text sentiment 1008, and motion data 1005. The video/image frames may be from videos or images captured by users and posted to social media. These video/image frames may also include additional training information such as viewer hotspots 1006 showing the most replayed frames. This additional training information may be used to generate labels for the video/image frames 1002 and additionally, in some implementations the additional training information may be used to label the audio data 1002, peripheral inputs 1003, eye tracking data 1004, text sentiment 1008, and motion data 1005. In the implementation shown a threshold 1007 is used to determine what viewership data 1006 is a hotspot which can be correlated with unimodal data. As shown here 1009 and 1010 are viewer hotspots as the viewership amount or replay amount exceeds the threshold 1007. This data may be used to discover associations between different input modalities and viewer hotspots that may not be possible to discover with unimodal data.

The system may generate highlights from the application may include image frames taken from the application (screenshots), replays in the form of sequences of image frames (videos) with audio, audio from application, audio recorded of the user while the application is in use, text captions indicating achievements within the application, replay data (save state information for the application so that a particular application scenario in the highlight can be replayed) etc. During training, the highlights such as snippets of video 1001 created by users and uploaded to social media may be used to train the highlight detection module to create similar application highlights. The interconnectedness of modern gaming systems allows multiple different modalities of data that can be used to classify highlights from the application. Here different modalities of data represent different inputs or input information type.

The multi-modal fusion of different types of inputs allows for the discovery of highlights which may provide the discovery of previously hidden highlight indicators and a reduction in processing because less processing intensive indicators of events may be discovered. For example and without limitation, during training the system may be configured to recognize that a certain sound 1002 occurs during periods of high interest 1010 from users as determine from video highlight replay data 1006 the trained multimodal neural network may generate highlights whenever that particular sound occurs as it has been correlated with interest and other more computational intensive indicators of interest such as image classification or object detection do not need to be used. In another example shown the system may be trained to identify motion data 1005 indicating a particular motion that may also be correlated with a period of high interest 1010 and as such other data may not be analyzed to determine a highlight when the motion occurs. The highlight detection module engine may also use peripheral input and/or time between inputs to correlate viewer interest with input data for example a series of button presses in quick succession 1003 may be identified as corresponding user interest as seen in the viewership data 1006 as such similar types of button presses may be classified as expressing user interest in other situations. Eye tracking 1004 inputs may be used to train the system to discover periods of interest 1009 in the application. Text input from users may have its sentiment 1008 classified and correlated with parts of video 1011 and viewer hotspots 1006 to determine a region of interest 1010. Finally, the sequence of image frames 1001 or structured data about things appearing in the image frames may be correlated with viewer hotspots 1006. In these examples unimodal modules trained on a particular modality of data provide feature data to a multimodal neural network which is trained to classify highlights from the application data using the features. Additionally, application data may be passed to a multimodal neural network. This may enable the multimodal neural network to correlate unimodal data or combinations of unimodal data with highlights that users may want to capture. The highlight may come as a time stamp for image frames or a time stamp of a particular image frame that should be highlighted.

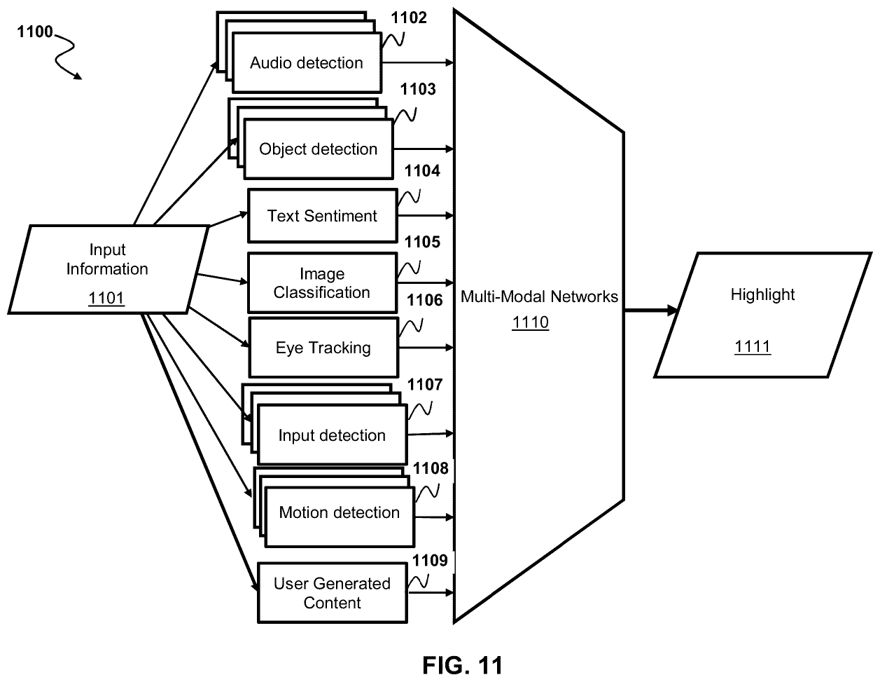

FIG. 11 is a diagram depicting an example layout of unimodal modules in a multi-modal recognition network of the highlight detection engine according to aspects of the present disclosure. As shown the highlight detection engine includes one or more unimodal modules operating on different modalities of input information 1101 and a multi-modal module which receives information from the unimodal modules. The input information 1101 may include structured or unstructured data or some combination of both structured and unstructured data. In the implementation shown the highlight detection engine 1100 includes unimodal modules, such as one or more audio detection modules 1102, one or more object detection modules 1103, a text and character extraction module 1104, an image classification module 1105, an eye tracking module 1106, one or more input detection modules 1107, one or more motion detection modules 1108, and a user generated content classifier 1109. The highlight detection engine also includes one or more multimodal neural network modules which take the outputs of the unimodal modules and generates highlights information 1111.

### Audio Detection Modules

The one or more audio detection modules 1102 may include one or more neural networks trained to classify audio data. Additionally, the one or more audio detection modules may include audio pre-processing stages and feature extraction stages. The audio preprocessing stage may be configured to condition the audio for classification by one or more neural networks.

Pre-processing may be optional because audio data is received directly from the input information 1101 and therefore would not need to be sampled and would ideally be free from noise. Nevertheless, the audio may be preprocessed to normalize signal amplitude and adjust for noise. In the case of recorded user sounds preprocessing may be necessary because recordings of user sounds are likely to be poorer quality and have more ambient sounds.

The feature extraction stage may generate audio features from the audio data to capture feature information from the audio. The feature extraction stage may apply transform filters to the pre-processed audio based on human auditory features such as for example and without limitation Mel Frequency cepstral coefficients (MFCCs) or based Spectral Feature of the audio for example short time Fourier transform. MFCC may provide a good filter selection for speech because human hearing is generally tuned for speech recognition additionally because most applications are designed for human use the audio may be configured for the human auditory system. Short Fourier Transform may provide more information about sounds outside the human auditory range and may be able to capture features of the audio lost with MFCC.

The extracted features are then passed to one or more of the audio classifiers. The one or more audio classifiers may be neural networks trained with a machine learning algorithm to classify sentiment from the extracted features for user sounds and classify user interest/excitement for application sounds. In some implementations the audio detection module may include speech recognition to convert speech into a machine-readable form and classify key words or sentences from the text. In some alternative implementations text generated by speech recognition may be passed to the text and character extraction module for further processing. According to some aspects of the present disclosure the classifier neural networks may be specialized to detect a single type of sentiment from the recorded user audio data or a single type of interest from the application audio data. For example and without limitation, there may be a classifier neural network trained to only classify features corresponding different sentiments (e.g., excited, interested, calm, annoyed, upset, etc.) and there may be another classifier neural network to recognize interesting sounds. As such for each event type there may be a different specialized classifier neural network trained to classify the event from feature data. Alternatively, a single general classifier neural network may be trained to classify every event from feature data. Or in yet other alternative implementations a combination of specialized classifier neural network and generalized classifier neural networks may be used. In some implementations the classifier neural networks may be application specific and trained off a data set that includes labeled audio samples from the application. In other implementations the classifier neural network may be a universal audio classifier trained to recognize interesting events or classify sentiment from a data set that includes labeled common audio samples. Many applications have common audio samples that are shared or slightly manipulated and therefore may be detected by a universal audio classifier. In yet other implementations a combination of universal and application specific audio classifier neural networks may be used. In either case the audio classification neural networks may be trained de novo or alternatively may be further trained from pre-trained models using transfer learning. Pre-trained models for transfer learning may include without limitation VGGish, Sound net, Resnet, Mobilenet. Note that for Resnet and Mobilenet the audio would be converted to spectrograms before classification.

In training the audio classifier neural networks, whether de novo or from a pre-trained module, the audio classifier neural networks may be provided with a dataset of game play audio. The dataset of gameplay audio used during training has known labels. The known labels of the data set are masked from the neural network at the time when the audio classifier neural network makes a prediction, and the labeled gameplay data set is used to train the audio classifier neural network with the machine learning algorithm after it has made a prediction as is discussed in the generalized neural network training section. In some implementations the universal neural network may also be trained with other datasets having known viewer hotspot or interest labels such as for example and without limitation movie sounds or YouTube video.

### Object Detection Modules

The one or more object detection modules 1103 may include one or more neural networks trained to classify objects that are interesting or exciting to users occurring within an image frame of video or an image frame of a still image. Additionally, the one or more object detection modules may include a frame extraction stage, an object localization stage, and an object tracking stage.

The frame extraction stage may simply take image frame data directly from the unstructured data. In some implementations the frame rate of video data may be down sampled to reduce the data load on the system. Additionally in some implementations the frame extraction stage may only extract key frames or I-frames if the video is compressed. Access to the full unstructured data also allows frame extraction to discard or use certain rendering layers of video. For example and without limitation, the frame extraction stage may extract the UI layer without other video layers for detection of UI objects or may extract non-UI rendering layers for object detection within a scene.

The object localization stage identifies interesting features within the image. The object localization stage may use algorithms such as edge detection or regional proposal. Alternatively, the neural network may include deep learning layers that are trained to identify interesting features within the image may be utilized.

The one or more object classification neural networks are trained to localize and classify interesting objects from the identified features. The one or more classification neural networks may be part of a larger deep learning collection of networks within the object detection module. The classification neural networks may also include non-neural network components that perform traditional computer vision tasks such as template matching based on the features. The interesting objects that the one or more classification neural networks are trained to localize and classify may be determined from at least one of viewership hotspot data and from screenshots or video clips generated by users. Interesting objects may include for example and without limitation, Game icons such as player map indicator, and map location indictor (Points of interest), item icons, status indicators, menu indicators, save indicators, and character buff indicators, UI elements such as health level, mana level, stamina level, rage level, quick inventory slot indicators, damage location indicators, UI compass indicators, lap time indicators, vehicle speed indicators, and hot bar command indicators, application elements such as weapons, shields, armors, enemies, vehicles, animals, trees, explosions, game set pieces, and other interactable elements.

According to some aspects of the present disclosure the one or more object classifier neural networks may be specialized to detect a single type of interesting object from the features. For example and without limitation, there may be an interesting object classifier neural network trained to only classify features corresponding to interesting game enemies. As such for each interesting object type there may be a different specialized classifier neural network trained to classify the object from feature data. Alternatively, a single general classifier neural network may be trained to classify every object from feature data. Or in yet other alternative implementations a combination of specialized classifier neural network and generalized classifier neural networks may be used. In some implementations the object classifier neural networks may be application specific and trained off a data set that includes label audio samples from the application. In other implementations the classifier neural network may be a universal object classifier trained to recognize objects from a data set that includes labeled frames that contain objects that are interesting to viewers as determined from the selection of frames by the user of viewership data on social media. Many applications have common objects that are shared or slightly manipulated and therefore may be detected by a universal object classifier. In yet other implementations a combination of universal and application specific object classifier neural networks may be used. In either case the object classification neural networks may be trained de novo or alternatively may be further trained from pre-trained models using transfer learning. Pre-trained models for transfer learning may include without limitation Faster R-CNN (Region-based convolutional neural network), YOLO (You only look once), SSD (Single shot detector), and Retinanet.

Frames from the application may be still images or may be part of a continuous video stream. If the frames are part of a continuous video stream the object tracking stage may be applied to subsequent frames to maintain consistency of the classification over time. The object tracking stage may apply known object tracking algorithms to associate a classified object in a first frame with an object in a second frame based on for example and without limitation the spatial temporal relation of the object in the second frame to the first and pixel values of the object in the first and second frame.

In training the object detection neural networks, whether de novo or from a pre-trained model, the object detection classifier neural networks may be provided with a dataset of game play video. The dataset of gameplay video used during training has known labels. The known labels of the data set are masked from the neural network at the time when the object classifier neural network makes a prediction, and the labeled gameplay data set is used to train the object classifier neural network with the machine learning algorithm after it has made a prediction as is discussed in the generalized neural network training section. In some implementations the universal neural network may also be trained with other datasets having known labels such as for example and without limitation real world images of objects, movies, or YouTube video.

### Text Sentiment

The text sentiment module 1104 may include a video preprocessing component, text detection component and text recognition component to extract and detect.

Where video frames contain text, the video preprocessing component may modify the frames or portions of frames to improve recognition of text. For example and without limitation, the frames may be modified by preprocessing de-blurring, de-noising, and contrast enhancement. In some situations, video preprocessing may not be necessary, e.g., if the user enters text into the system in machine readable form.

Text detection components may be applied to frames and configured to identify regions that contain text if user entered text is not in a machine-readable form. Computer vision techniques such as edge detection and connected component analysis may be used by the text detection components. Alternatively, text detection may be performed by a deep learning neural network trained to identify regions containing text.

Low level Text recognition may be performed by optical character recognition. The recognized characters may be assembled into words and sentences. Higher level text recognition may then analyze assembled words and sentences to determine sentiment. In some implementations, such “higher level text recognition” may be done using natural language processing models that perform specific tasks, such as text classification. In some implementations, a dictionary may be used to look up and tag words and sentences that indicate sentiment or interest. Alternatively, a neural network may be trained with a machine learning algorithm to classify Sentiment and/or interest. For example and without limitation, the text recognition neural networks may be trained to recognize words and/or phrases that indicate interest, excitement, concentration etc. Similar to above, the text recognition neural network, natural language processing model, or dictionary may be universal and shared between applications or specialized for each application or a combination of the two. For example, some implementations may use customized models that are fine-tuned for each application, e.g., each game title, but with similar or common model architectures.

In training the high-level text recognition neural networks may be trained de novo or using transfer learning from a pretrained neural network. Pretrained neural networks that may be used with transfer learning include for example and without limitation Generative Pretrained Transformer (GPT) 2, GPT 3, GPT 4, Universal Language Model Fine-Tuning (ULMFiT), Embeddings from Language Models (ELMo), Bidirectional Encoder Representations from Transformers (BERT) and similar. Whether de novo or from a pre-trained model, the high-level Text recognition neural networks may be provided with a dataset of user entered text. The dataset of user entered text used during training has known labels for sentiment. The known labels of the data set are masked from the neural network at the time when the high-level text recognition neural network makes a prediction, and the labeled user entered text data set is used to train the high level text recognition neural network with the machine learning algorithm after it has made a prediction as is discussed in the generalized neural network training section. In some implementations the universal neural network may also be trained with other datasets having known labels such as for example and without limitation real world text, books, or websites.

### Image Classification

The Image classification module 1105 classifies the entire image of the screen whereas object detection decomposes elements occurring within the image frame. The task of image classification is similar to object detection except it occurs over the entire image frame without an object localization stage and with a different training set. An image classification neural network may be trained to classify interest from an entire image. In some implementations, the image classification module may include one or more neural networks configured or to detect similarities between images. Interesting images may be images that are frequently captured as screenshots or in videos by users or frequently re-watched on social media and may be for example victory screens, game over screens, death screens, frames of game replays etc. Examples of pre-trained models include Vision Transformer (ViT) models, Residual Network (ResNet) models, and convext models.

The image classification neural networks may be trained de novo or trained using transfer learning from a pretrained neural network. Whether de novo or from a pre-trained module, the image classification neural networks may be provided with a dataset of gameplay image frames. The dataset of gameplay image frames used during training has known labels of interest. The known labels of the data set are masked from the neural network at the time when the image classification neural network makes a prediction, and the labeled gameplay data set is used to train the image classification neural network with the machine learning algorithm after it has made a prediction as is discussed in the generalized neural network training section. In some implementations the universal neural network may also be trained with other datasets having known labels such as for example and without limitation images of the real world, videos of gameplay or game replays. Some examples of pre-trained image recognition models that can be used for transfer learning include, but are not limited to, VGG, ResNet, EfficientNet, DenseNet, MobileNet, ViT, GoogLeNet, Inception, and the like.

### Eye Tracking

The eye tracking module 1106 may take gaze tracking data from a HUD and correlate the eye tracking data to areas of the screen and interest. During eye tracking an infrared emitter illuminates the user's eyes with infrared light causing bright reflections in the pupil of the user. These reflections are captured by one or more cameras focused on the eyes of the user in the HUD. The eye tracking system may go through a calibration process to correlate reflection with eye positions. The eye tracking module may detect indicators of interest such as fixation and correlate those indicators of interest to particular areas of the screen and frames in the application.

Detecting fixation and other indicators of interest may include calculating mean and variance of gaze position along with timing. Alternatively complex machine learning methods such as principal component analysis or independent component analysis may be used. These extraction methods may discover underlying behavioral elements in the eye movements.

Additional deep learning machine learning models may be used to associate the underlying behavior elements of the eye movements to events occurring in the frames to discover indicators of interest from eye tracking data. For example and without limitation, eye tracking data may indicate that the user's eyes fixate for a particular time period during interesting scenes as determined from viewer hotspots or screenshot/replay generation by the user. This information may be used during training to associate that particular fixation period as a feature for highlight training.

Machine learning models may be trained de novo or trained using transfer learning from a pretrained neural networks. Pretrained neural networks that may be used with transfer learning include for example and without limitation Pupil labs and PyGaze.

### Input Detection

The input information 1101 may include inputs from peripheral devices. The input detection module 1107 may take the inputs from the peripheral devices and identify the inputs that correspond to interest or excitement from the user. In some implementations the input detection module 1107 may include a table containing inputs timing thresholds that correspond to interest from the user. For example and without limitation, the table may provide an input threshold of 100 milliseconds between inputs representing interest/excitement from the user; these thresholds may be set per application. Additionally, the table may exclude input combination or timings used by the current application thus tracking only extraneous input combinations and/or timings by the user that may indicate user sentiments. Alternatively, the input detection module may include one or more input classification neural networks trained to recognize interest/excitement of the user. Different applications may require different input timings and therefore each application may require a customized model. Alternatively, according to some aspects of the present disclosure one or more of the input detection neural networks may be universal and shared between applications. In yet other implementations a combination of universal and specialized neural networks is used. Additionally in alternative implementations the input classification neural networks may be highly specific with a different trained neural network to identify one specific indicator of interest/excited for the structured data.

The input classification neural networks may be provided with a dataset including peripheral inputs occurring during use of the computer system. The dataset of peripheral inputs used during training have known labels for excitement/interest of the user. The known labels of the data set are masked from the neural network at the time when the input classification neural network makes a prediction, and the labeled data set of peripheral inputs is used to train the input classification neural network with the machine learning algorithm after it has made a prediction as is discussed in the generalized neural network training section. A specialized input classification neural network may have a data set that consists of recordings of inputs sequences that occur during operation of a specific application and no other applications; this may create a neural network that is good at predicting actions for a single application. In some implementations, a universal input classification neural network may also be trained with other datasets having known labels such as for example and without limitation excited/interested input sequences across many different applications. By way of example, and not by way of limitation, for time series event data, the input classification neural networks may leverage a seq-to-seq language model, e.g., a Bert based models, like roberta-bert, distillery, etc. for the task of classification. In this context, the task of classification refers to determining whether a given sequence of events is related to someone getting excited over something.

### Motion Detection

Many applications also include a motion component in the input information 1101 set that may indicate interest/excitement of the user. The motion detection module 1108 may take the motion information from the input information 1101 evaluate the motion information to determine user sentiment. A simple approach to motion detection may include simply providing different thresholds for excitement and outputting an excitement feature each time an element from an inertial measurement unit exceeds the threshold. For example and without limitation, the system may include a 2-gravity acceleration threshold for movements in both X and Y direction to indicate the user is waving their hands in excitement. Additionally, the thresholds may exclude known movements associated with application commands allowing the system to track extraneous movements that indicate user sentiment. Another alternative approach is neural network based motion classification. In this implementation the motion detection module may include the components of motion preprocessing, feature selection and motion classification.

The motion preprocessing component conditions the motion data to remove artifacts and noise from the data. The preprocessing may include noise floor normalization, mean selection, standard deviation evaluation, Root mean square torque measurement, and spectral entropy signal differentiation.

The feature selection component takes preprocessed data and analyzes the data for features. Selecting features using techniques for example and without limitation principal component analysis, correlational analysis, sequential forward selection, backwards elimination, and mutual information.

Finally, the selected features are applied to the motion classification neural networks trained with a machine learning algorithm to classify sentiment from motion information. In some implementations the selected features are applied to other machine learning models which do not include a neural network for example and without limitation, decision trees, random forests, and support vector machines. According to some aspects of the present disclosure one or more of the motion classification neural networks may be universal and shared between applications. In some implementations the one or more motion classification neural networks may be specialized for each application and trained on a data set including interest or excitement motions of users for the specific chosen application. In yet other implementation a combination of universal and specialized neural networks is used. Additionally in alternative implementations the motion classification neural networks may be highly specific with a different trained neural network to identify user sentiment for each application.

The motion classification neural networks may be provided with a dataset including motion inputs occurring during use of the computer system. The dataset of motion inputs used during training has known labels for user sentiment. The known labels of the data set are masked from the neural network at the time when the motion classification neural network makes a prediction, and the labeled data set of motion inputs is used to train the motion classification neural network with the machine learning algorithm after it has made a prediction as is discussed in the generalized neural network training section. A specialized motion classification neural network may have a data set that consists of recordings of inputs sequences that occur during operation of a specific application and no other application; this may create a neural network that is good at predicting actions for a single application. In some implementations a universal motion classification neural network may also be trained with other datasets having known labels such as for example and without limitation input sequences across many different applications.

### User Generated Content Classification

The system may also be configured to classify sentiments occurring within user generated content. As used herein user generated content may be data generated by the user on the system coincident with use of the application. For example and without limitation, user generated content may include chat content, blog posts, social media posts, screen shots, user generated documents. The User Generated Content Classification module 1109 may include components from other modules such as the text sentiment module and the object detection module to place the user generated content in a form that may be used as context data. For example and without limitation, the User Generated Content Classification may decompose text and character extraction components to identify contextually important statements made by the user in a chat room. As a specific, non-limiting example the user may make a statement in chat such as ‘I'm so excited’ or ‘check this out’ which may be detected and used to indicate sentiment for a time point in the application.

The User Generated Content Classification module 1109 may include video classification, image classification, and text classification neural networks. These may be configured similarly to the text sentiment module 1104 and the image classification module 1105 discussed above. The main difference is in the input to the User Generated Content Classification module 1109, e.g., from user recorded content.

### Multi-Modal Networks

The multimodal highlight detection neural networks 1110 fuse the information generated by the modules 1102-1109 and generate a time stamped prediction which is used to retrieve image data from the structured data to create a highlight 1111 from the separate modal networks of the modules. In some implementations the data from the separate modules are concatenated together to form a single multi-modal vector. The multi-modal vector may also include the data from structured data.

The output of a multimodal highlight detection neural network 1110 may include a classification associated with a timestamp of when the highlight occurred in the application data. The classification may simply confirm that a highlight occurred or may provide a sentiment associated with the highlight. A buffer of image frames correlated by stamp may be kept by the device or on a remote system. The highlight detection engine may use the timestamp associated with the classification to retrieve the image frame to create the highlight 1111 from the buffer. In some implementations the output of the multimodal highlight detection neural network includes a series or range of time stamps, and the highlight detection engine may request the series of timestamps or range of time stamps from the buffer to generate a video highlight. In some alternative implementations the highlight detection engine may include a buffer which receives image frame data and organizes the image frames by timestamp.

The multi-modal neural networks 1110 may be trained with a machine learning algorithm to take the multi-modal vector and predict highlight data 1111. Training the multi-modal neural networks 1110 may end to end training of all of the modules with a data set that includes labels for multiple modalities of the input data. During training, the labels of the multiple input modalities are masked from the multi-modal neural networks before prediction. The labeled data set of multi-modal inputs is used to train the multi-modal neural networks with the machine learning algorithm after it has made a prediction as is discussed in the generalized neural network training section.

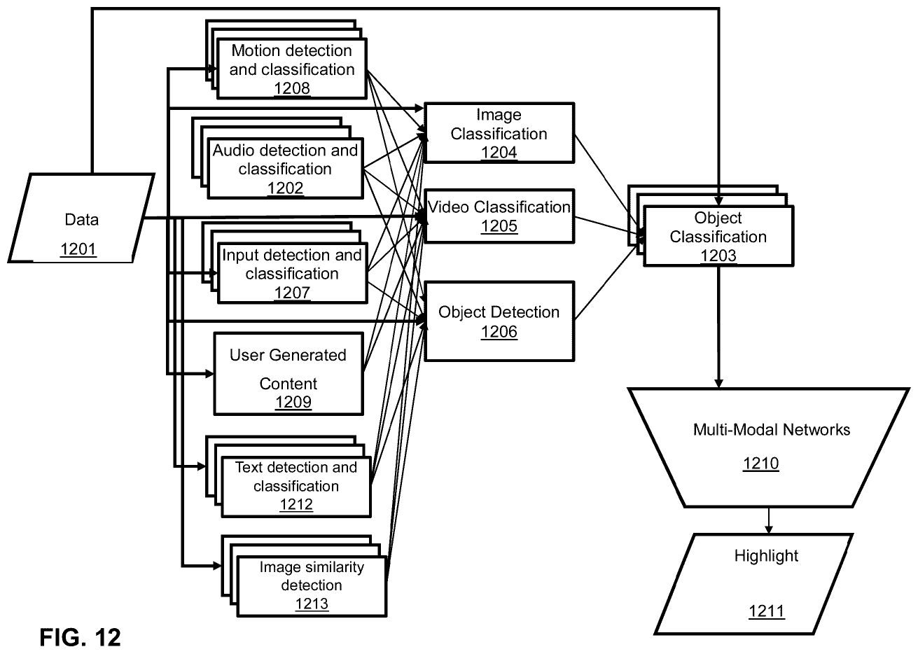

FIG. 12 is a diagram depicting an example layout of cascaded filtering unimodal modules in a multi-modal recognition network of the highlight detection engine according to aspects of the present disclosure. In the implementation shown the highlight detection includes unimodal modules arranged in a hierarchy. The first layer of the hierarchy shown may include motion detection 1208, audio detection 1202, input detection 1207, and user generated content module 1209. The modules that make up the first layer of the hierarchical structure and may be thought of as filters for the next layer. These modules take structured and/or unstructured data 1201 and generate interest feature data from the structured data. The structured input data includes a large amount of extraneous data that does not provide useful information for highlight features. The modules in the first later of the hierarchy are thus configured to discard information that does not generate and preserve the location in the structured data where a highlight feature is predicted. The interest feature generated by one or more modules in the first layer of the hierarchy includes both a highlight feature from the structured data and define a segment of the structured application data where the highlight featured data was generated. The segment of structured application data may be a portion of the application data as defined by for example and without limitation, a time stamp or range of time stamps. The first layer of unimodal modules chosen such that the features generated by the modules require less processing time or processing power to generate.

The second layer of unimodal modules includes eye tracking 1206, text sentiment 1204 and Image Classification 1205. These modules are configured to operate on the segment of data 1201 defined by the interest feature and pass through the highlight feature data generated by the first layer of unimodal modules. As shown the second layer of unimodal modules receives both interest features and the application data. In some alternative implementations the first layer of unimodal modules may pass the segment of application data that generated the feature to modules of the second layer. The second layer of unimodal modules may generate refined interest features from the segment of data 1201 specified by the previous layer of unimodal modules. The refined interest features may include a highlight feature generated from the application data and further define the segment of the structured application data where the highlight feature was generated. In some cases, a unimodal module may not find a highlight feature in the segment of application data defined by the previous layer of unimodal modules and in which case, the feature data will be discarded without passing through the unimodal module. In some alternative implementations the interest feature may be passed through the unimodal module, but a refined interest feature will be generated without a highlight feature from the unimodal module or with a null or placeholder value indicating that no feature was generated for this particular module.

In some implementations the second layer of unimodal modules may provide the refined features directly to the multimodal neural network 1210. In such an implementation the multimodal neural network may predict a highlight 1211 from the refined interest features and the interest features. The implementation shown includes a third layer of unimodal modules which receive the refined interest features. The shown layer includes an object detection module 1203. The unimodal modules in the second layer may be chosen to require less processing time or processing power than the unimodal modules in the third layer. The module or modules of this third layer 1203 may take the refined interest features from the previous layer and structured application data to generate further refined interest features. The further refined interest features include a highlight feature and may further define the segment of the application data that the highlight feature was generated from. Additionally, the further refined interest features may pass through the highlight features generated by the previous layers. In some implementations third layer of unimodal modules may also filter out information by discarding interest features and refined interest features when a highlight is not predicted from the application data with any of the unimodal module 1203 in the third layer. Alternatively, the interest features and refined interest features may be passed through the unimodal module, but a refined interest feature will be generated without a highlight feature from the unimodal module or with a null or placeholder value indicating that no feature was generated for this particular module. While the implementation shown includes three layers of interconnected unimodal modules, aspects of the present disclosure are not so limited; implementations may include any number of layers of unimodal modules arranged in a hierarchy with initial layers performing less processor time or computational resource-intensive operations than later layers.

The further refined interest features are then passed to the multimodal neural network 1210 which as discussed above is trained with a machine learning algorithm to predict highlight information 1211. The highlight information may include timestamps that may then be used to retrieve highlight data such as video and audio stored in a buffer to generate a highlight screenshot or highlight video.

Cascaded filtering with Highlight detection may take place entirely on the client device or on a networked server. In some implementations the first layer of unimodal modules be located on the client device and the interest features may be sent to the remote servers for additional layer of unimodal processing and highlight detection and generation. In other implementations, multiple remote devices may take part in the detection of highlights wherein the client device sends application data to an intermediary remote server where one or more layers of unimodal modules generate interest features or refined features and the intermediary server my send the interest features or refined interest to final server where the highlights are detected and may be generated.

### Generalized Neural Network Training

The NNs discussed above may include one or more of several different types of neural networks and may have many different layers. By way of example and not by way of limitation the neural network may include one or multiple convolutional neural networks (CNN), recurrent neural networks (RNN) and/or dynamic neural networks (DNN). The Motion Decision Neural Network may be trained using the general training method disclosed herein.

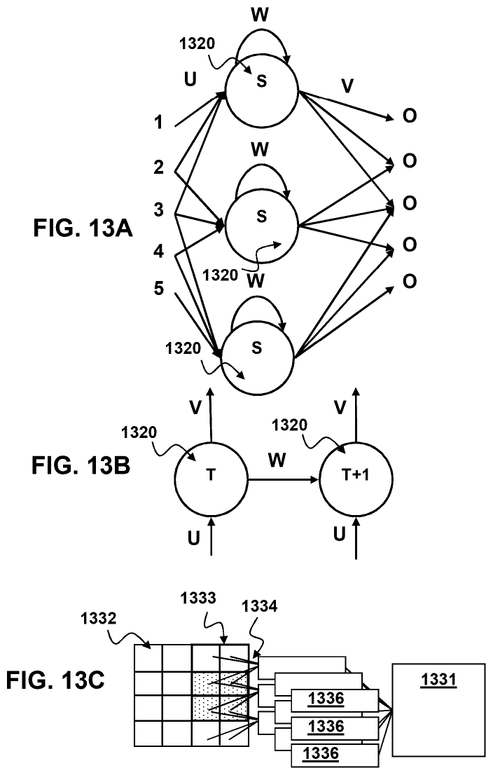

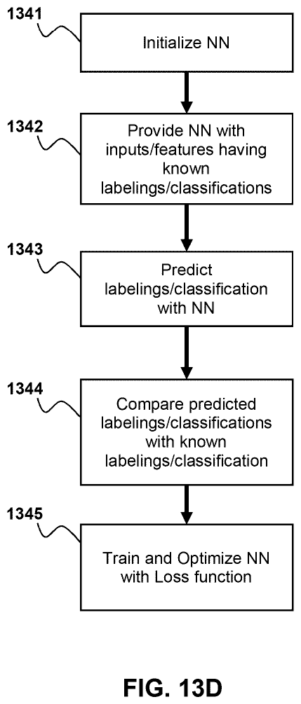

By way of example, and not limitation, FIG. 13A depicts the basic form of an RNN that may be used, e.g., in the trained model. In the illustrated example, the RNN has a layer of nodes 1320, each of which is characterized by an activation function S, one input weight U, a recurrent hidden node transition weight W, and an output transition weight V. The activation function S may be any non-linear function known in the art and is not limited to the (hyperbolic tangent (tanh) function. For example, the activation function S may be a Sigmoid or ReLu function. Unlike other types of neural networks, RNNs have one set of activation functions and weights for the entire layer. As shown in FIG. 13B, the RNN may be considered as a series of nodes 1320 having the same activation function moving through time T and T+1. Thus, the RNN maintains historical information by feeding the result from a previous time T to a current time T+1.

In some implementations, a convolutional RNN may be used. Another type of RNN that may be used is a Long Short-Term Memory (LSTM) Neural Network which adds a memory block in a RNN node with input gate activation function, output gate activation function and forget gate activation function resulting in a gating memory that allows the network to retain some information for a longer period of time as described by Hochreiter & Schmidhuber “Long Short-term memory” Neural Computation 9(8):1735-1780 (1997), which is incorporated herein by reference.

FIG. 13C depicts an example layout of a convolution neural network such as a CRNN, which may be used, e.g., in the trained model according to aspects of the present disclosure. In this depiction, the convolution neural network is generated for an input 1332 with a size of 4 units in height and 4 units in width giving a total area of 16 units. The depicted convolutional neural network has a filter 1333 size of 2 units in height and 2 units in width with a skip value of 1 and a channel 1336 of size 9. For clarity in FIG. 13C only the connections 1334 between the first column of channels and their filter windows is depicted. Aspects of the present disclosure, however, are not limited to such implementations. According to aspects of the present disclosure, the convolutional neural network may have any number of additional neural network node layers 1331 and may include such layer types as additional convolutional layers, fully connected layers, pooling layers, max pooling layers, local contrast normalization layers, etc. of any size.

As seen in FIG. 13D Training a neural network (NN) begins with initialization of the weights of the NN at 1341. In general, the initial weights should be distributed randomly. For example, an NN with a tanh activation function should have random values distributed between

$$- \frac{1}{\sqrt{n}} and \frac{1}{\sqrt{n}}$$

where n is the number of inputs to the node.

After initialization, the activation function and optimizer are defined. The NN is then provided with a feature vector or input dataset at 1342. Each of the different features vectors that are generated with a unimodal NN may be provided with inputs that have known labels. Similarly, the multimodal NN may be provided with feature vectors that correspond to inputs having known labeling or classification. The NN then predicts a label or classification for the feature or input at 1343. The predicted label or class is compared to the known label or class (also known as ground truth) and a loss function measures the total error between the predictions and ground truth over all the training samples at 1344. By way of example and not by way of limitation the loss function may be a cross entropy loss function, quadratic cost, triplet contrastive function, exponential cost, etc. Multiple different loss functions may be used depending on the purpose. By way of example and not by way of limitation, for training classifiers a cross entropy loss function may be used whereas for learning pre-trained embedding a triplet contrastive function may be employed. The NN is then optimized and trained, using the result of the loss function, and using known methods of training for neural networks such as backpropagation with adaptive gradient descent etc., as indicated at 1345. In each training epoch, the optimizer tries to choose the model parameters (i.e., weights) that minimize the training loss function (i.e., total error). Data is partitioned into training, validation, and test samples.

During training, the Optimizer minimizes the loss function on the training samples. After each training epoch, the model is evaluated on the validation sample by computing the validation loss and accuracy. If there is no significant change, training can be stopped, and the resulting trained model may be used to predict the labels of the test data.

Thus, the neural network may be trained from inputs having known labels or classifications to identify and classify those inputs. Similarly, a NN may be trained using the described method to generate a feature vector from inputs having a known label or classification. While the above discussion is relation to RNNs and CRNNS the discussions may be applied to NNs that do not include Recurrent or hidden layers.

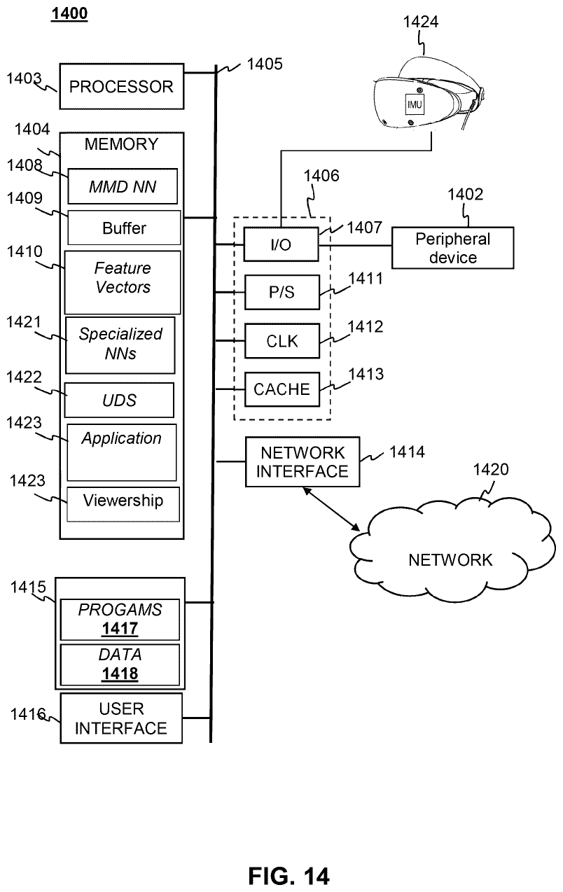

FIG. 14 depicts a system according to aspects of the present disclosure. The system may include a computing device 1400 coupled to a user peripheral device 1402 and a HUD 1424. The peripheral device 1402 may be a controller, touch screen, microphone or other device that allows the user to input speech data into the system. The HUD 1424 may be a Virtual Reality (VR) headset, Altered Reality (AR) headset or similar. The HUD may include one or more IMUs which may provide motion information to the system. Additionally, the peripheral device 1402 may also include one or more IMUs.

The computing device 1400 may include one or more processor units and/or one or more graphical processing units (GPU) 1403, which may be configured according to well-known architectures, such as, e.g., single-core, dual-core, quad-core, multi-core, processor-coprocessor, cell processor, and the like. The computing device may also include one or more memory units 1404 (e.g., random access memory (RAM), dynamic random-access memory (DRAM), read-only memory (ROM), and the like).

The processor unit 1403 may execute one or more programs, portions of which may be stored in memory 1404 and the processor 1403 may be operatively coupled to the memory, e.g., by accessing the memory via a data bus 1405. The programs may be configured to implement training of a multimodal NN 1408. Additionally, the Memory 1404 may contain programs that implement training of a NN configured to generate feature vectors 1410. The memory 1404 may also contain software modules such as a multimodal neural network module 1408, the UDS system 1422 and Specialized NN Modules 1421. The multimodal neural network module and specialized neural network modules are components of the highlight detection engine. The Memory may also include one or more applications 1423, viewership information 1423 from social media and a time stamped buffer of image and audio from the application 1409. The overall structure and probabilities of the NNs may also be stored as data 1418 in the Mass Store 1415. The processor unit 1403 is further configured to execute one or more programs 1417 stored in the mass store 1415 or in memory 1404 which cause the processor to carry out a method for training a NN from feature vectors 1410 and/or structured data. The system may generate Neural Networks as part of the NN training process. These Neural Networks may be stored in memory 1404 as part of the Multimodal NN Module 1408, or Specialized NN Modules 1421. Completed NNs may be stored in memory 1404 or as data 1418 in the mass store 1415. The programs 1417 (or portions thereof) may also be configured, e.g., by appropriate programming, to receive or generate screenshots and/or videos submitted to social media from the time stamped buffer 1409.

The computing device 1400 may also include well-known support circuits, such as input/output (I/O) 1407, circuits, power supplies (P/S) 1411, a clock (CLK) 1412, and cache 1413, which may communicate with other components of the system, e.g., via the bus 1405. The computing device may include a network interface 1614. The processor unit 1403 and network interface 1414 may be configured to implement a local area network (LAN) or personal area network (PAN), via a suitable network protocol, e.g., Bluetooth, for a PAN. The computing device may optionally include a mass storage device 1415 such as a disk drive, CD-ROM drive, tape drive, flash memory, or the like, and the mass storage device may store programs and/or data. The computing device may also include a user interface 1416 to facilitate interaction between the system and a user. The user interface may include a keyboard, mouse, light pen, game control pad, touch interface, or other device.

The computing device 1400 may include a network interface 1414 to facilitate communication via an electronic communications network 1420. The network interface 1414 may be configured to implement wired or wireless communication over local area networks and wide area networks such as the Internet. The device 1400 may send and receive data and/or requests for files (e.g. viewership information) via one or more message packets over the network 1420. Message packets sent over the network 1420 may temporarily be stored in a buffer 1409 in memory 1404.

Aspects of the present disclosure leverage artificial intelligence to detect sentiment and generate highlights from input structured and/or unstructured data. The input data can be analyzed and correlated with viewership data and user screenshot or replay generation to discover and capture highlights to suggest for the user.

While the above is a complete description of the preferred embodiment of the present disclosure, it is possible to use various alternatives, modifications, and equivalents. Therefore, the scope of the present disclosure should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A system for detection and generation of a gameplay highlight comprising;
a processor;
a memory communicatively coupled to the processor, wherein the memory includes executable instructions configured to cause the processor to carry out a method for gameplay highlight detection comprising:
running an application;
receiving one or more inputs for the application from a user;
providing the one or more inputs for the application and application data to a trained highlight detection neural network; and
running the trained highlight detection neural network wherein the trained highlight detection neural network is trained to predict at least one highlight determined from at least one of the application data and the one or more inputs for the application.

2. The system of claim 1 wherein the trained highlight detection neural network is a multimodal neural network that includes two or more unimodal neural networks trained to generate highlight feature information from at least one of the application data and the one or more inputs for the application.

3. The system of claim 2 wherein the two or more unimodal neural networks includes an audio detection neural network trained with a machine learning algorithm to highlight features from the application data.

4. The system of claim 2 wherein the two or more unimodal neural networks include an audio detection neural network trained with a machine learning algorithm to generate highlight features of the application data using the one or more inputs for the application from the user wherein the one or more inputs for the application includes recorded sounds from the user.

5. The system of claim 2 wherein the two or more unimodal neural networks include an audio detection neural network trained with a machine learning algorithm to generate highlight features of the application data using one or more inputs for a different application from the user wherein the one or more inputs for a different application includes recorded sounds from the user.

6. The system of claim 2 wherein the two or more unimodal neural networks include an input detection neural network trained with a machine learning algorithm to generate highlight features of the application data using the one or more inputs for the application from the user.

7. The system of claim 2 wherein the two or more unimodal neural networks include a text sentiment neural network trained with a machine learning algorithm to generate highlight features of the application data using the one or more inputs for application from the user wherein the one or more inputs from the user includes text input from the user.

8. The system of claim 2 wherein the two or more unimodal neural networks include a text sentiment neural network trained with a machine learning algorithm to generate highlight features of the application data using one or more inputs for a different application from the user wherein the one or more inputs for the different application from the user includes text input from the user.

9. The system of claim 2 wherein the two or more unimodal neural networks include an eye tracking neural network trained with a machine learning algorithm to generate highlight features of the application data using eye tracking input from the user.

10. The system of claim 2 wherein the two or more unimodal neural networks include a screen classification neural network neural network trained with a machine learning algorithm to generate highlight features of the application data using image frames from the application data.

11. The system of claim 1 wherein the instructions in the memory further comprise executable instructions configured to associate the at least one highlight with a time stamp for a sequence of image frames from the application.

12. The system of claim 11 wherein the sequence of image frames includes audio data.

13. A method for training a multimodal highlight detection neural network comprising:
providing a multi-modal highlight detection neural network with labeled structured application data and masked structured application state data wherein the labeled structured application data include labels of at least one highlight in the application state data that are masked in masked structured application data, wherein the structured application data includes data corresponding to one or more inputs for an application; and
training the multi-modal highlight detection neural network with the masked structured application data to predict at least one highlight in application data with a machine learning algorithm using the labeled structured application data.

14. The method of claim 13, further comprising training a unimodal neural network module to generate highlight features from application data, wherein training the unimodal neural network includes providing the unimodal neural network with labeled unimodal structured application data wherein the labels are masked before the unimodal neural network module makes a prediction and the training the unimodal neural network module with a machine learning algorithm using the labeled unimodal structured application data.

15. The method of claim 14 wherein the unimodal neural network is an audio detection neural network configured to classify highlight features from the unimodal structured application data and the labeled unimodal structured application data includes data corresponding to recorded sounds from a user.

16. The method of claim 14 wherein the unimodal neural network is an input detection neural network configured to classify highlight features from the unimodal structured application data and the labeled unimodal structured application data includes data corresponding to one or more peripheral inputs from a user.

17. The method of claim 14 wherein the unimodal neural network is a text sentiment neural network configured to classify highlight features from the unimodal structured application data and the labeled unimodal structured application data includes data corresponding to text inputs from a user.

18. The method of claim 14 wherein the unimodal neural network is an eye tracking neural network configured to classify highlight features from the unimodal structured application data and the labeled unimodal structured application data includes data eye tracking data of a user.

19. The method of claim 14 wherein the unimodal neural network is a screen classification neural network configured to classify highlight features from the unimodal structured application data and the labeled unimodal structured application data includes data corresponding to one or more image frames from the application.

20. The method of claim 14 wherein the unimodal neural network is a sound detection neural network configured to classify highlight features from the unimodal structured application data and the labeled unimodal structured application data includes data corresponding to sounds from the application.

21. A device for detection and generation of a gameplay highlight comprising;
a data handler configured to receive structured application data from an application including one or more inputs for an application from a user; and
a trained highlight detection neural network wherein the trained highlight detection neural network is trained with a machine learning algorithm to predict at least one highlight determined from at least one of the application data and the one or more inputs for the application.

22. The device of claim 21 wherein the trained highlight detection neural network is a multimodal neural network that includes two or more unimodal neural networks trained to generate highlight feature information from at least one of the application data and the one or more inputs for the application.
